(19) United States
(12) Patent Application Publication
(10) Pub. No.: US 2025/0253595 A1
(43) Pub. Date: Aug. 7, 2025

(54) CONNECTOR ASSEMBLY

(71) Applicant: Molex, LLC, Lisle, IL (US)

(72) Inventors: Ming-Huei Kao, New Taipei City (TW); Tsai-Hui Chien, New Taipei City (TW)

(21) Appl. No.: 19/036,033

(22) Filed: Jan. 24, 2025

(30) Foreign Application Priority Data
Feb. 7, 2024 (CN) 202410174239.4

(51) Int. Cl. H01R 13/717; H01R 12/72; H01R 13/447; H01R 13/627; H01R 13/639; H01R 13/6581

(52) U.S. Cl. CPC H01R 13/7172; H01R 13/447; H01R 13/6273; H01R 13/639; H01R 13/6581; H01R 12/721

(57) ABSTRACT

A connector assembly includes a guiding shield cage, a side cover plate, a light guide member and a first assembling construction. The guiding shield cage includes a side wall. The side cover plate is assembled to the side wall of the guiding shield cage. The light guide member includes a plurality of light guiding pipes. Each light guiding pipe has a light inputting end and a light outputting end. The first assembling construction is provided between the light guide member and the side cover plate, and is used to assemble the light guide member on the side cover plate. The first assembling construction includes an interference cooperating construction and an elastic latching construction. By that the light guide member and the side cover plate are provided therebetween with the first assembling construction which allows the light guide member and the side cover plate to cooperate with each other, the light guide member is capable of being stably and indeed fixed on the side cover plate.

### TECHNICAL FIELD

The present disclosure relates to a connector assembly, and particularly relates to a connector assembly which has a light guide member.

### BACKGROUND

Chinese patent document CN110364871B (corresponding to U.S. Pat. No. 10,950,983B2) discloses a side wall of a cage and light guiding pipes are formed thereon with a latching structure, the latching structure includes a first latching structure which is adapted to position the light guiding pipes in a vertical direction and a second latching structure which is adapted to position the light guiding pipes in a horizontal direction. The first latching structure includes a first connecting post which extends along the horizontal direction and is connected between the two corresponding adjacent light guiding pipes and a first latching member which has a first C-shaped latching groove adapted to latch over the first connecting post. The second latching structure includes a second connecting post which extends along the vertical direction and is connected between the two corresponding adjacent light guiding pipes and a second latching member which has a second C-shaped latching groove adapted to latch over the second connecting post.

However, the first latching member and the second latching member are stamped members which are formed by stamping the side wall of the cage, that is, it needs to stamp apertures on the side wall of the cage to form the latching members, these apertures will lower an electromagnetic interference suppressing effect of the cage. In addition, the latching member and the connecting post latch with each other therebetween only by means of the C-shaped latching groove, such a latching mechanism is prone to make the connecting post improperly disengage the C-shaped latching groove from an opening of the C-shaped latching groove, an assembling structure is not sufficient in strength and thus is not firm.

### SUMMARY

Therefore, an object of the present disclosure is to provide a connector assembly which can improve at least one aforementioned problem.

Accordingly, a connector assembly of the present disclosure comprises a guiding shield cage, a side cover plate, a light guide member and a first assembling construction. The guiding shield cage comprises a side wall. The side cover plate is assembled to the side wall of the guiding shield cage. The light guide member comprises a plurality of light guiding pipes. Each light guiding pipe has a light inputting end and a light outputting end. The first assembling construction is provided between the light guide member and the side cover plate and is used to assemble the light guide member on the side cover plate. The first assembling construction comprises an interference cooperating construction and an elastic latching construction.

In some embodiments, the interference cooperating construction has a retaining hole which is formed to the light guide member, and a retaining piece which is provided to the side cover plate. In an assembling direction that the light guide member faces the side cover plate, the retaining piece is fixed in the retaining hole by interference cooperation.

In some embodiments, a side edge of the retaining piece has a front protruding portion and a recessed portion which is positioned behind the front protruding portion. The retaining hole therein has an internal protruding portion which cooperates with the recessed portion of the side edge of the retaining piece. The front protruding portion interferes with the internal protruding portion in the retaining hole in an inserting process of the retaining piece.

In some embodiments, the side edge of the retaining piece further has a rear protruding portion which is positioned behind the recessed portion, the recessed portion is positioned between the front protruding portion and the rear protruding portion.

In some embodiments, the elastic latching construction has a latch block which is provided to the light guide member, and a latch piece which is provided to the side cover plate and is elastic. In the assembling direction that the light guide member faces the side cover plate, the latch piece latches the latch block.

In some embodiments, the light guide member further has a latch supporting portion which is integrally connected to the plurality of light guiding pipes, the latch supporting portion of the light guide member is formed with the retaining hole and the latch block.

In some embodiments, the latch supporting portion comprises a supporting rod and a plurality of connecting rods connected to the plurality of light guiding pipes. The supporting rod of the light guide member is formed with the retaining hole, and allows the latch block to be provided thereon.

In some embodiments, the latch piece has a latch hole which is used to latch the latch block.

In some embodiments, a side of the latch block which faces the latch piece is provided with a guiding surface. A side of the latch piece which faces the latch block is provided with a guiding edge which cooperates with the guiding surface.

In some embodiments, the connector assembly further comprises a base seat and a second assembling construction. The base seat comprises a plurality of light guiding pipe receiving holes. The plurality of light guiding pipe receiving holes are respectively used to receive light inputting ends of the plurality of the light guiding pipes. The second assembling construction is provided between the light guide member and the base seat.

In some embodiments, the second assembling construction comprises a plurality of latching blocks which are respectively provided to the light inputting ends of the plurality of the light guiding pipes, and a plurality of latching grooves which are respectively formed to inner walls of the plurality of light guiding pipe receiving holes of the base seat. The plurality of latching blocks respectively latch the plurality of the latching grooves.

In some embodiments, a material of the base seat is a soft material containing a rubber.

In some embodiments, the guiding shield cage further comprises an assembling piece which protrudes from the side wall. The side cover plate has an assembling hole. The assembling piece passes through the assembling hole of the side cover plate, and latches the side cover plate.

In some embodiments, the guiding shield cage further comprises a partitioning frame. The partitioning frame has the assembling piece. The side wall has an assembling hole. The assembling hole of the side cover plate corresponds to the assembling hole of the side wall. The assembling piece outwardly and sequentially passes through the assembling hole of the side wall and the assembling hole of the side cover plate, and latches the side cover plate.

A connector assembly of the present disclosure comprises a guiding shield cage, a light guide member and a first assembling construction. The light guide member is assembled on the guiding shield cage and comprises light guiding pipes, the light guiding pipe has a light inputting end and a light outputting end. The first assembling construction is provided between the light guide member and the guiding shield cage and is used to position the light guide member to the guiding shield cage. The first assembling construction comprises an interference cooperating construction. The interference cooperating construction has a retaining hole and a retaining piece. The retaining piece is fixed in the retaining hole by interference cooperation. A side edge of the retaining piece has a front protruding portion and a recessed portion which is positioned behind the front protruding portion. The retaining hole therein has an internal protruding portion which cooperates with the recessed portion of the side edge of the retaining piece. The front protruding portion interferes with the internal protruding portion in the retaining hole in an inserting process of the retaining piece.

In some embodiments, the side edge of the retaining piece further has a rear protruding portion which is positioned behind the recessed portion, the recessed portion is positioned between the front protruding portion and the rear protruding portion.

In some embodiments, the first assembling construction further comprises an elastic latching construction. The elastic latching construction has a latch block and a latch piece which is elastic. The latch piece latches the latch block.

In some embodiments, the connector assembly further comprises a side cover plate. The side cover plate is assembled on the guiding shield cage and allows the retaining piece and the latch piece to be provided thereon. The light guide member is assembled on the side cover plate. The light guide member is formed with the retaining hole and allows the latch block be provided thereon. The retaining hole is assembled and fixed to the retaining piece in an assembling direction that the light guide member faces the side cover plate. The latch block is assembled and fixed to the latch piece in the assembling direction that the light guide member faces the side cover plate.

In some embodiments, the light guide member further has a latch supporting portion which is integrally connected to the light guiding pipes, the latch supporting portion of the light guide member is formed with the retaining hole and the latch block.

In some embodiments, the latch supporting portion comprises a supporting rod and a plurality of connecting rods connected to the light guiding pipes, the supporting rod of the light guide member is formed with the retaining hole, and allows the latch block to be provided thereon.

In some embodiments, the latch piece has a latch hole which is used to latch the latch block.

In some embodiments, the latch block has a guiding surface which faces the latch piece in an assembling process. A side of the latch piece is further provided with a guiding edge which faces the latch block and cooperates with the guiding surface.

In some embodiments, the connector assembly further comprises a base seat and a second assembling construction. The base seat comprises light guiding pipe receiving holes. The light guiding pipe receiving holes are respectively used to receive light inputting ends of the light guiding pipes. The second assembling construction is provided between the light guide member and the base seat.

In some embodiments, the second assembling construction comprises latching blocks which are respectively provided at the light inputting ends of the he light guiding pipes and are respectively received in the light guiding pipe receiving holes, and latching grooves which are respectively formed to the base seat and are used to respectively latch the latching blocks.

In some embodiments, a material of the base seat is a soft material containing a rubber.

The beneficial effect of the present disclosure of lies in that: by that the light guide member is provided on the side cover plate, the corresponding side wall of the guiding shield cage does not need a construction and apertures which are used to assemble the light guiding pipe, at the same time by that the side cover plate is assembled to the corresponding side wall of the guiding shield cage, the side cover plate is capable of covering some openings or opened holes on the side wall, the side cover plate has a double technical effect of both an electromagnetic interference (EMI) shielding function and being used to assemble the light guide member. Moreover, by that the light guide member and the side cover plate are provided therebetween with the first assembling construction which allows the light guide member and the side cover plate to cooperate with each other and the light guide member and the base seat are provided therebetween with the second assembling construction which allows the light guide member and the base seat to cooperate with each other, the light guide member and the base seat are capable of being stably and indeed fixed on the side cover plate. Moreover, by that the light guide member and the side cover plate are therebetween provided with the interference cooperating construction and the elastic latching construction, the light guide member is capable of being more firmly fixed, and the light guide member is further capable of being detached. Moreover, by that in a process that the retaining piece inserts into the retaining hole, the front protruding portion firstly interferes with and scratches the internal protruding portion, although the internal protruding portion is partially scratched but still substantially maintains as a protruding block to pass over the front protruding portion and then enters into the recessed portion, in turn is limited by the front protruding portion and the rear protruding portion, conversely, when the retaining piece withdraws from the retaining hole, the internal protruding portion will scratch the front protruding portion again and still maintains as a protruding block to pass over the front protruding portion, in this way, it is beneficial for the retaining hole to be capable of being assembled and used again.

### BRIEF DESCRIPTION OF THE DRAWINGS

Other features and effects of the present disclosure will be apparent from embodiments with reference to the drawings, in which:

FIG. 1 is a perspective view of an embodiment of a connector assembly of the present disclosure and a pluggable module;

FIG. 2 is another perspective view of the embodiment;

FIG. 3 is a perspective exploded view of the embodiment of FIG. 2 with a plurality of grounding members, a receptacle connector and an external heat sink of the embodiment removed;

FIG. 4 is a partial perspective view of the embodiment illustrating a side cover plate assembled on a guiding shield cage and constructions of a plurality of retaining pieces and a latch piece;

FIG. 5 is a partially cut-away enlarged perspective view illustrating a connecting relationship among a base seat, a light guide member and a first assembling construction and the side cover plate in the embodiment;

FIG. 6 is a perspective exploded view illustrating implementing details of the base seat, the light guide member, the first assembling construction and the side cover plate;

FIG. 7 is an incomplete cross sectional view taken along a line VII-VII of FIG. 5;

FIG. 8 is a side view of the corresponding FIG. 5;

FIG. 9 is an incomplete cross sectional view taken along an IX-IX of FIG. 8; and

FIG. 10 is an incomplete cross sectional view taken along an X-X of FIG. 8.

### DETAILED DESCRIPTION

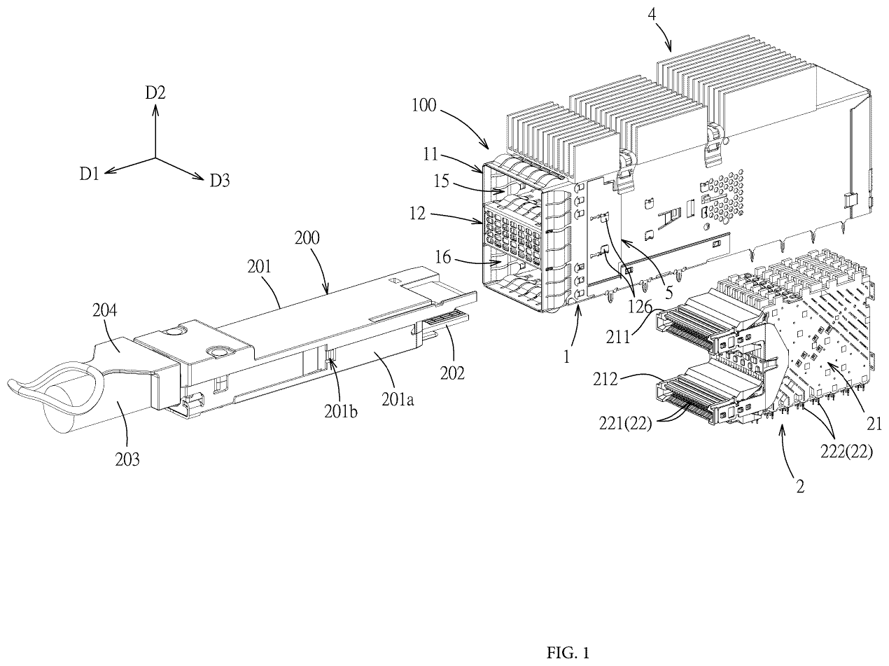

Referring to FIG. 1 to FIG. 3, an embodiment of a connector assembly 100 of the present disclosure is illustrated. The connector assembly 100 is adapted to be provided to a circuit board (not shown) and is capable of allowing a pluggable module 200 to mate therewith. The pluggable module 200 has a shell member 201, a mating circuit board 202, and a cable 203. The shell member 201 has an inserting portion 201a. The mating circuit board 202 is positioned to a front end of the shell member 201 (the front end of the shell member 201 is one end adjacent to the connector assembly 100, and a rear end of the shell member 201 is the other end away from the connector assembly 100), is provided to the inserting portion 201a, and protrudes from the inserting portion 201a. The cable 203 is provided to the rear end of the shell member 201 and is electrically connected to the mating circuit board 202. The connector assembly 100 includes a guiding shield cage 1, a receptacle connector 2, an external heat sink 4, a covering plate 5, a side cover plate 6, a base seat 7, a light guide member 8, a first assembling construction 9a and a second assembling construction 9b.

The guiding shield cage 1 may be formed by processing, such as stamping and bending, a metal plate. The guiding shield cage 1 is adapted to be provided to the circuit board, and includes a cage 11, a partitioning frame 12 and a plurality of grounding members 14. The cage 11 has a top wall 111, a bottom wall 112, two side walls 113, a rear wall 114 and a plurality of inserting legs 115. The top wall 111 extends along a front-rear direction D1 (a direction to which an arrow points is front, and an opposite direction is rear). The two side walls 113 are spaced apart from each other along a left-right direction D3 (a direction to which an arrow points is right, and an opposite direction is left), that is, the two side walls 113 respectively extend downwardly from a left side edge and a right side edge of the top wall 111 along an up-down direction D2 (a direction to which an arrow points is up, and an opposite direction is down). The bottom wall 112 may be separately formed and be assembled to bottom portions of the two side walls 113 or may be integrally formed to the bottom portions of the two side walls 113, and is spaced apart from the rear wall 114 to make a bottom opening (not shown) remained. The rear wall 114 is connected to a rear end of the top wall 111 and is connected to rear sides of the two side walls 113. The plurality of inserting legs 115 are spaced apart from each other, are provided to bottom edges of the two side walls 113, extend downwardly and are adapted to be fixed on the circuit board and/or be connected to grounding traces (not shown).

The partitioning frame 12 is provided in the cage 11, the partitioning frame 12 and the cage 11 together define an upper receiving space 15 and a lower receiving space 16. A rear segment of the upper receiving space 15 and a rear segment of the lower receiving space 16 are communicated with each other. A front opening of the upper receiving space 15 or a front opening of the lower receiving space 16 is capable of allowing the inserting portion 201a of the pluggable module 200 to insert therein from front to rear along the front-rear direction D1. In the embodiment, each side wall 113 of the cage 11 has a plurality of assembling holes 113a which are penetratingly formed. The partitioning frame 12 further has a plurality of assembling pieces 126 which extend to outer sides of the two side walls 113 from a left side and a right side of the partitioning frame 12. The plurality of the assembling piece 126 respectively pass through the assembling holes 113a of the two side walls 113 from an interior of the two side walls 113 toward an exterior of the two side walls 11, protrude from the corresponding side walls 113, then are bent and fixed, so that the partitioning frame 12 is stably assembled to the cage 11. Moreover, each side wall 113 of the cage 11 further has two elastic piece openings 113e which respectively correspond to the upper receiving space 15 and the lower receiving space 16, and two inward extending elastic pieces 113f which are constructed to the two elastic piece openings 113e respectively and obliquely extend toward an interior of the guiding shield cage 1 and toward the rear of the guiding shield cage 1. A left side and a right side of the inserting portion 201a of the pluggable module 200 are respectively provided with two locking recessed grooves 201b which correspondingly cooperate with the two inward extending elastic pieces 113f, so as to generate a locking effect. In addition, the pluggable module 200 further has a locking release member 204, when the locking release member 204 is pulled, the inward extending elastic piece 113f can be pushed out of the locking recessed groove 201b. In addition, an internal space of the partitioning frame 12 may be assembled with an internal heat sink (not shown).

The plurality of grounding members 14 are respectively positioned at a front end of the cage 11 and a front end of the partitioning frame 12, are distributed to an outer side and an inner side of the cage 11 and an upper side and a lower side of the partitioning frame 12. In the embodiment, the connector assembly 100 may be provided to a mounting hole (not shown) of a casing (not shown). Each grounding member 14 has a plurality of elastic portions 141 which each are arc, extend rearwardly and are elastically deformable. The elastic portion 141 of the plurality of elastic portions 141 which is positioned to the outer side of the cage 11 is used to contact the mounting hole of the casing, the elastic portion 141 of the plurality of elastic portions 141 which is positioned to the inner side of the cage 11 or is positioned to the partitioning frame 12 is used to contact the pluggable module 200.

Referring to FIG. 1, the receptacle connector 2 is provided on the circuit board and is received in a rear segment of the guiding shield cage 1 (that is, where the rear segment of the upper receiving space 15 and the rear segment of the lower receiving space 16 which are communicated with each other) from down to up via the bottom opening. The receptacle connector 2 has a housing 21 which is insulative, and a plurality of terminals 22 which are provided to the housing 21. The housing 21 has an upper slot 211 and a lower slot 212 which are toward the front and are arranged along the up-down direction D2. The upper slot 211 and the lower slot 212 respectively correspond to the upper receiving space 15 and the lower receiving space 16, and are capable of allowing the mating circuit board 202 to insert therein. Each terminal 22 has a contact portion 221 which is positioned in the upper slot 211 or the lower slot 212, and a tail portion 222 which extends downwardly out of a bottom portion of the housing 21 and is used to be mechanically and electrically connected to the circuit board. When the pluggable module 200 inserts into the upper receiving space 15, the upper slot 211 allows the mating circuit board 202 to insert therein so as to make the mating circuit board 202 electrically connected with the terminals 22 positioned in the upper slot 211. When the pluggable module 200 inserts into the lower receiving space 16, the lower slot 212 allows the mating circuit board 202 to insert therein so as to make the mating circuit board 202 electrically connected with the terminals 22 positioned in the lower slot 212.

Referring to FIG. 1 to FIG. 3, the external heat sink 4 is provided with a fin-shaped structure, is provided at an upper window 111a of the top wall 111 of the cage 11 of the guiding shield cage 1, and contact the pluggable module 200 which inserts into the upper receiving space 15 to transfer heat generated during operation of the pluggable module 200 to the outside. The covering plate 5 is a metal plate, and is assembled to the outer side of one of the two side walls 113 of the cage 11 of the guiding shield cage 1. In the embodiment, the covering plate 5 is assembled on the side wall 113 which is on the right and covers the two elastic piece openings 113e and some existing opened holes of the side wall 113 which is on the right, so as to increase an electromagnetic interference (EMI) suppressing effect. The covering plate 5 has a plurality of assembling holes 51 which correspond to some of the plurality of assembling holes 113a of the corresponding side wall 113. The corresponding assembling pieces 126 at a side of the partitioning frame 12 adjacent to the covering plate 5 respectively outwardly and sequentially pass through the assembling holes 113a of the corresponding side wall 113 and the plurality of assembling hole 51 of the covering plate 5 and then are bent and fixed, and latch to the covering plate 5, so that the covering plate 5 is stably assembled to the cage 11.

Referring to FIG. 1 to FIG. 4, the side cover plate 6 also is a metal plate, and is separably assembled to the outer side of the other of the two side walls 113 of the cage 11 of the guiding shield cage 1. In the embodiment, the side cover plate 6 is assembled on the side wall 113 which is on the left and covers the two elastic piece openings 113e and some existing opened holes of the side wall 113 on the left, so as to increase electromagnetic interference (EMI) suppressing effect. The side cover plate 6 has a plurality of assembling holes 61 which correspond to some of the plurality of assembling holes 113a of the corresponding side wall 113. The corresponding assembling pieces 126 of the partitioning frame 12 at a side of the partitioning frame 12 adjacent to the side cover plate 6 respectively outwardly and sequentially pass through the assembling holes 113a of the corresponding side wall 113 and the plurality of assembling holes 61 of the side cover plate 6 and then are bent and fixed, and latch to the side cover plate 6, so that the side cover plate 6 is stably assembled to the cage 11.

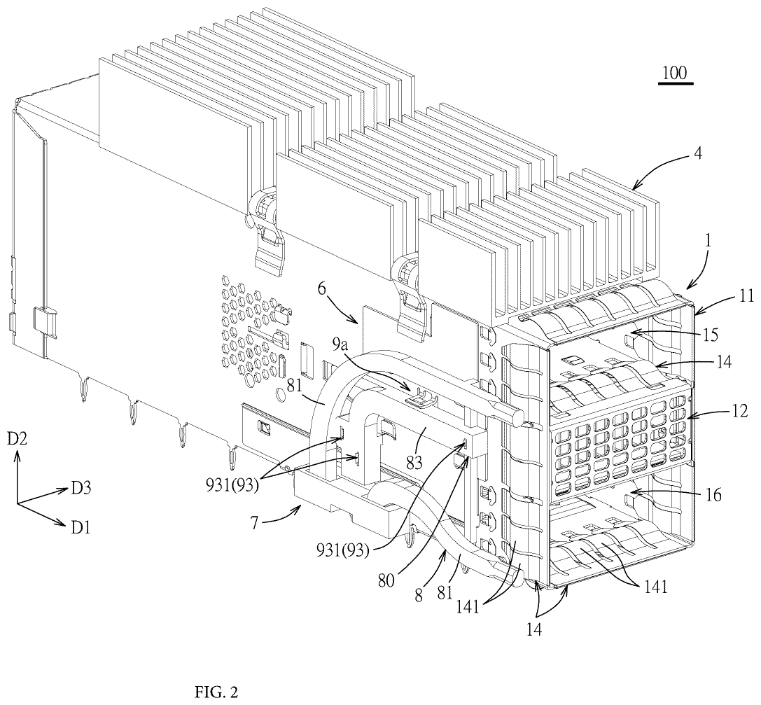

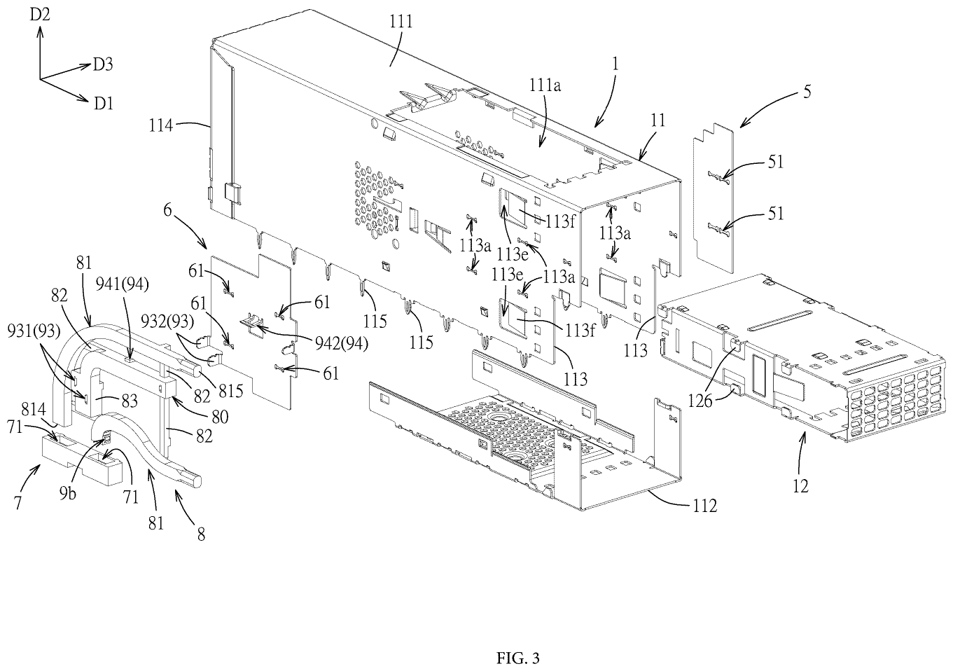

Referring to FIG. 2 and FIG. 3, the base seat 7 is positioned to an outer side of the side cover plate 6 (a side away from the guiding shield cage 1), and extends along the front-rear direction D1. The base seat 7 includes a plurality of (here two as example) light guiding pipe receiving holes 71 which are formed to a top surface of the base seat 7, penetrate downwardly to a bottom surface of the base seat 7, and allow the light guide member 8 to insert therein. In the embodiment, a material of the base seat 7 is a soft material containing a rubber, which is beneficial to assembling of the base seat 7 and the light guide member 8, and it also is easier to detach the base seat 7 and the light guide member 8. Moreover, the base seat 7 is not transparent, and has a light-shading effect.

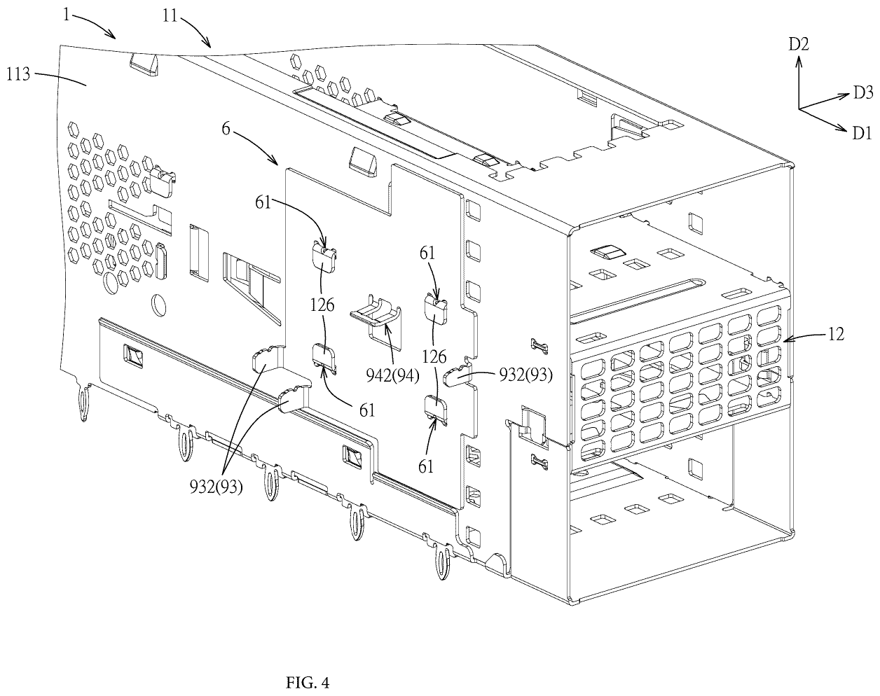

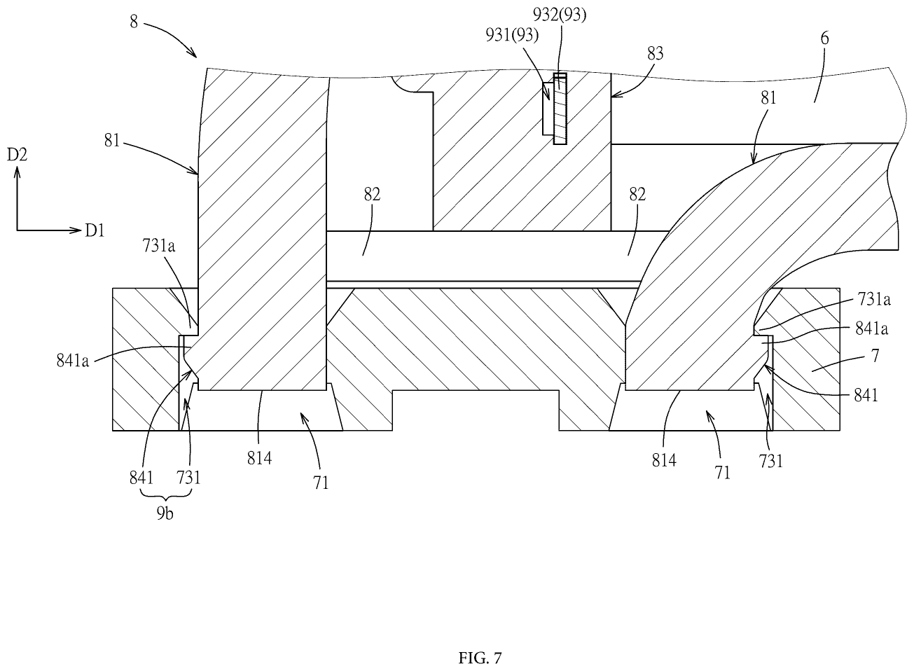

Referring to FIG. 4 to FIG. 7, the light guide member 8 is separably assembled to the outer side of the side cover plate 6 (an inner side of the side cover plate 6 is one side which faces the guiding shield cage 1, the outer side of the side cover plate 6 is the other side which is opposite to the guiding shield cage 1) via the first assembling construction 9a, and is separably assembled on the base seat 7 via the second assembling construction 9b. The light guide member 8 has a plurality of light guiding pipes 81 (here two light guiding pipes 81 as example). Each light guiding pipe 81 has a forward extending segment 811 which is positioned in the front of the light guiding pipe 81 and extends forwardly, a downward extending segment 812 which is positioned at the rear of the light guiding pipe 81 and extends downwardly, a bending segment 813 which is positioned between the forward extending segment 811 and the downward extending segment 812, a light inputting end 814 which is positioned to a tip of the downward extending segment 812, and a light outputting end 815 which is positioned to a tip of the forward extending segment 811. The two forward extending segments 811 are arranged in the up-down direction D2 and are spaced apart from each other, the two downward extending segments 812 are arranged in the front-rear direction DI and are spaced apart from each other. The light inputting ends 814 of the two light guiding pipes 81 are respectively received in the two light guiding pipe receiving holes 71 of the base seat 7. A space between a bottom portion of each light guiding pipe receiving hole 71 and the light inputting end 814 of the corresponding light guiding pipe 81 is used to accommodate a light emitting member (not shown) on the circuit board.

In the embodiment, the light guide member 8 further has a supporting portion 80 which is integrally connected to the two light guiding pipes 81. The supporting portion 80 includes a supporting rod 83 which is positioned between the two adjacent light guiding pipes 81 and a plurality of connecting rods 82 which are connected to the two light guiding pipes 81. The supporting rod 83 curvedly extends from a side which is adjacent to the light outputting ends 815 toward the rear (toward a direction close to the bending segments 813) and toward the down (toward a direction close to the light inputting ends 814) along an extending direction of the two light guiding pipes 81 to slightly be L-shaped.

Referring to FIG. 4 to FIG. 6, the first assembling construction 9a is provided between the light guide member 8 and the side cover plate 6, and is used to assemble the light guide member 8 on the side cover plate 6. The first assembling construction 9a includes an interference cooperating construction 93 and an elastic latching construction 94. The interference cooperating construction 93 has a plurality of retaining holes 931 (here three retaining holes 931 as example) which are formed to the light guide member 8, and a plurality of retaining pieces 932 (here three retaining pieces 932 as example) which are provided to the side cover plate 6. Specifically, the plurality of retaining holes 931 penetrate an inner side and an outer side of the supporting rod 83 (the inner side of the supporting rod 83 is a side which faces the side cover plate 6, the outer side of the supporting rod 83 is the other side which is opposite to the side cover plate 6), and are respectively positioned to a front segment and a rear segment of the supporting rod 83. The retaining piece 932 is in form of thin piece shape, and extends from a side edge of the side cover plate 6 along the left-right direction D3 toward a direction which is away from the guiding shield cage 1 or extends toward the light guide member 8, and positions of the plurality of retaining pieces 932 respectively correspond to the plurality of retaining holes 931. The retaining piece 932 may be formed by integrally cutting the edge of the side cover plate 6 and then bending outwardly, but the present disclosure is not limited thereto.

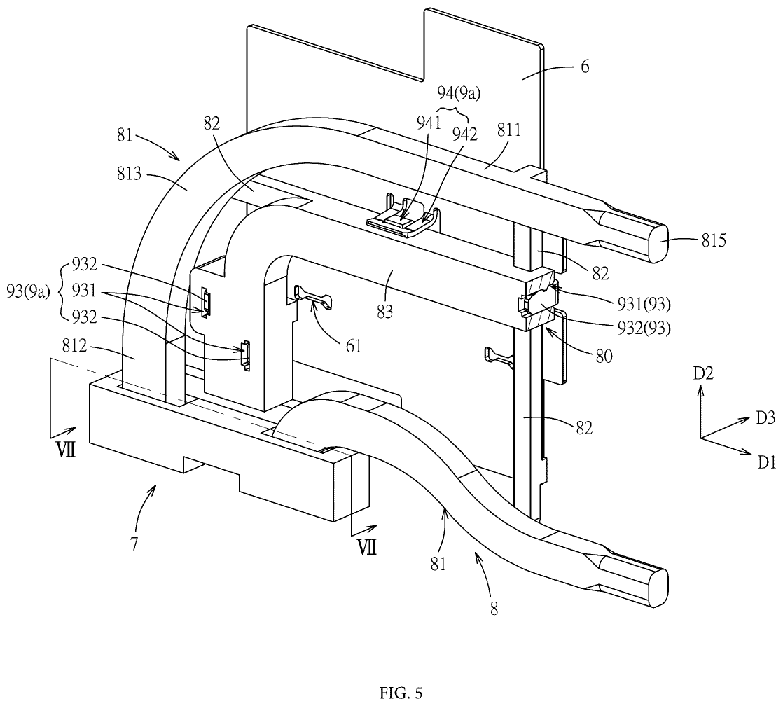

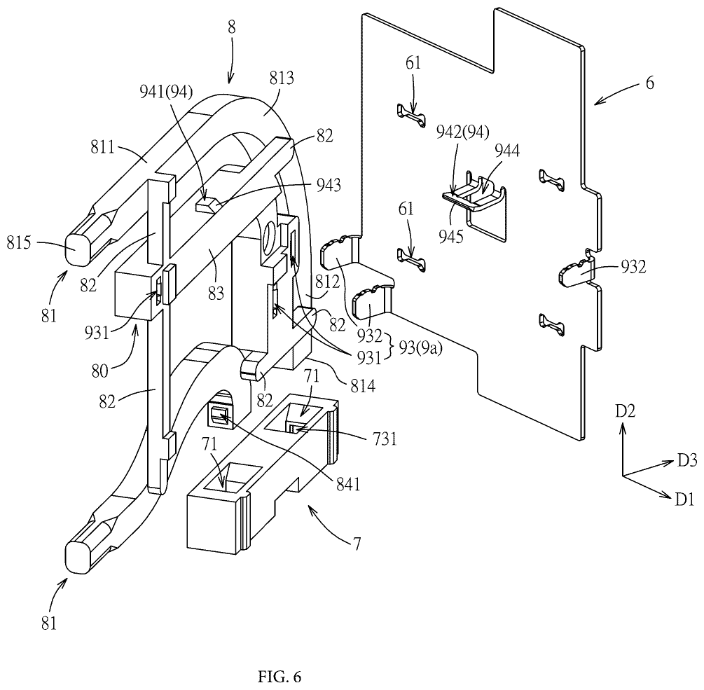

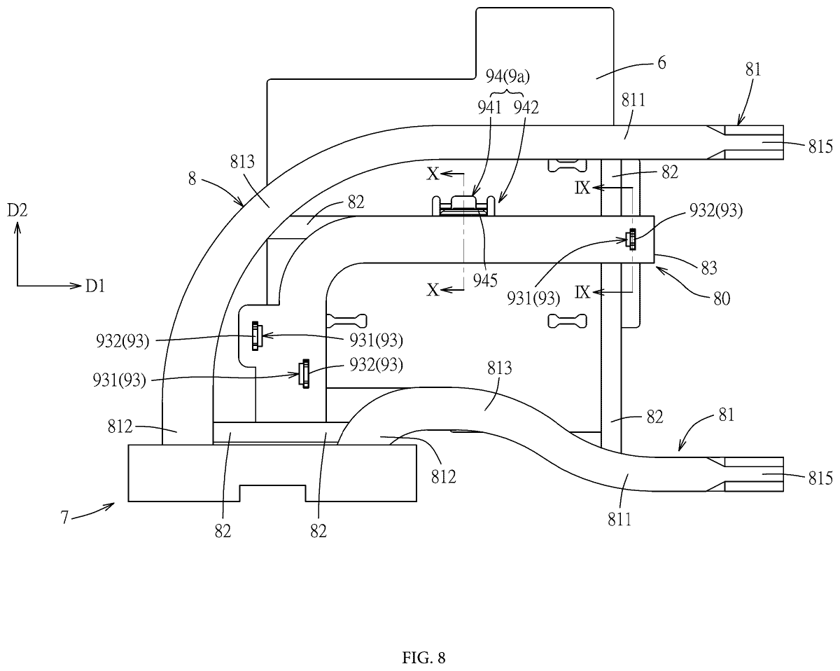

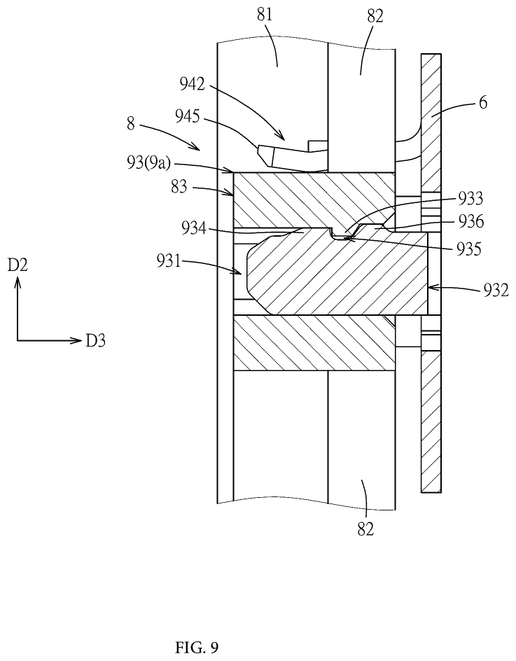

Referring to FIG. 5, FIG. 6, FIG. 8 and FIG. 9, when assembled, the light guide member 8 is capable of being assembled to the side cover plate 6 in an assembling direction that the light guide member 8 faces the side cover plate 6 (that is, in the left-right direction D3 toward a direction that the light guide member 8 is close to the side cover plate 6) and in a manner that the plurality of retaining holes 931 of the light guide member 8 are respectively aligned with the plurality of retaining pieces 932, in this way, as shown in FIG. 9, in the assembling direction that the light guide member 8 faces the side cover plate 6, the plurality of retaining pieces 932 are respectively fixed in the plurality of the retaining holes 931 with interference cooperation, so as to increase the retention force that the light guide member 8 is retained on the side cover plate 6.

In a process that the retaining piece 932 inserts into the retaining hole 931, one end of the retaining piece 932 adjacent to an opening the retaining hole 931 is defined as front, the other end of the retaining piece 932 adjacent to the side cover plate 6 is defined as rear. An upper side edge of each retaining piece 932 has a front protruding portion 934, a recessed portion 935 positioned behind the front protruding portion 934, and a rear protruding portion 936 positioned behind the recessed portion 935. Specifically, the front protruding portion 934 and the rear protruding portion 936 of each retaining piece 932 are arranged front and rear along an inserting direction that the retaining piece 932 inserts into the retaining hole 931 and are provided to the upper side edge of the retaining piece 932, the recessed portion 935 is positioned between the front protruding portion 934 and the rear protruding portion 936. Moreover, a height of the rear protruding portion 936 that the rear protruding portion 936 protrudes upwardly in the up-down direction D2 is larger than a height of the front protruding portion 934 that the front protruding portion 934 protrudes upwardly in the up-down direction D2. Each retaining hole 931 therein has an internal protruding portion 933 which protrudes downwardly from a top portion of an inner wall of the retaining hole 931 toward an interior of the retaining hole 931 and cooperates with the recessed portion 935 of the upper side edge of the retaining piece 932.

In a process that the light guide member 8 is assembled to the side cover plate 6, firstly, the plurality of retaining holes 931 are respectively aligned with the plurality of retaining pieces 932; next, the plurality of retaining holes 931 respectively allow the plurality of retaining pieces 932 to insert therein in a direction which the plurality of retaining pieces 932 are toward the plurality of retaining holes 931 (parallel to extending directions of plurality of the retaining holes 931 and extending directions of plurality of the retaining pieces 932), during insertion, the front protruding portion 934 firstly interferes with scratches the internal protruding portion 933, although the internal protruding portion 933 is partially scratched, the internal protruding portion 933 still substantially maintains as a protruding block to pass over the front protruding portion 934 and then enters into the recessed portion 935, in turn is limited by the front protruding portion 934 and the rear protruding portion 936. Similarly, when the retaining piece 932 withdraws from the retaining hole 931, the internal protruding portion 933 will scratch the front protruding portion 934 again, and still maintain as a protruding block to pass over the front protruding portion 934, in this way, it is beneficial for the retaining hole 931 to be capable of being assembled and used again. In addition, besides that the front protruding portion 934 of the retaining piece 932 generates interference with the internal protruding portion 933 in the retaining hole 931 in the inserting process of the retaining piece 932, the front protruding portion 934 further may be provided to interfere with the inner wall of the retaining hole 931, in this way, it is capable of further increasing the retention force that the light guide member 8 is retained on the side cover plate 6. Further, the rear protruding portion 936 also may be provided to interfere with the inner wall of the retaining hole 931. The front protruding portion 934, the recessed portion 935 and the rear protruding portion 936 of the embodiment are positioned to the same side (an upper side) of the retaining piece 932, but also may be provided to each of two sides (the upper side and a lower side) of the retaining piece 932, the top portion and a bottom portion of the inner wall of the retaining hole 931 also may be respectively with the corresponding internal protruding portions 933 which protrude toward the interior of the retaining hole 931.

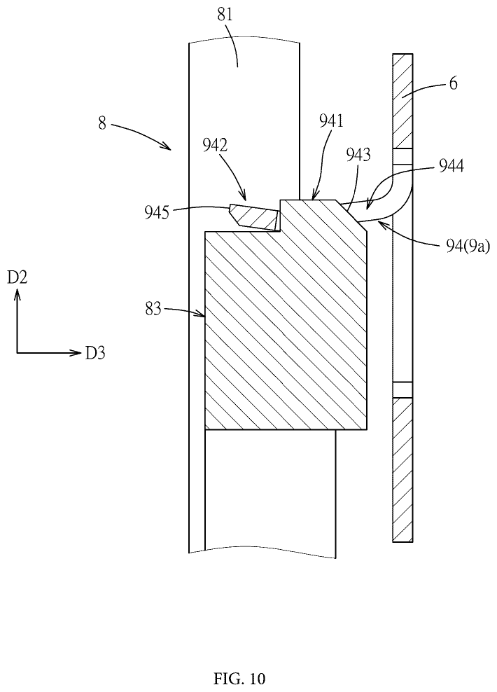

Referring to FIG. 4 to FIG. 6, FIG. 8 and FIG. 10, the elastic latching construction 94 has a latch block 941 which is provided to the light guide member 8, and a latch piece 942 which is provided to the side cover plate 6 and is elastic. Specifically, the latch block 941 protrudes upwardly from a top surface of the supporting rod 83. The latch piece 942 extends from the side cover plate 6 toward the light guide member 8, and has a latch hole 944 which penetrates an upper surface and a lower surface of the latch piece 942. The latch hole 944 allows the latch block 941 to enter therein from down to up, is used to latch the latch block 941. As shown in FIG. 10, preferably, the latch block 941 has a guiding surface 943 which faces the latch piece 942 in the assembling process, that is, the guiding surface 943 obliquely extends toward the latch piece 942 and toward the down. A side of the latch piece 942 further has a guiding edge 945 which faces the latch block 941 and cooperates with the guiding surface 943 in the assembling process. A bottom surface of the guiding edge 945 obliquely extends toward the latch block 941 and toward the up.

Referring to FIG. 5, FIG. 6, FIG. 8 and FIG. 10, in the assembling process, the light guide member 8 moves toward the side cover plate 6 and approaches the side cover plate 6 in the assembling direction that the light guide member 8 faces the side cover plate 6 (that is, in the left-right direction D3 toward a direction that the light guide member 8 is close to the side cover plate 6) and in a manner that the latch block 941 is aligned with the latch piece 942, at this time, the guiding edge 945 of the latch piece 942 will firstly slide upwardly along the guiding surface 943 of the latch block 941, which makes the latch piece 942 elastically deformed; next, the light guide member 8 moves continuously to make the latch hole 944 of the latch piece 942 aligned with the latch block 941 so that the latch block 941 enters into the latch hole 944 and the latch piece 942 latches the latch block 941.

Referring to FIG. 4 to FIG. 7, the second assembling construction 9b is provided between the light guide member 8 and the base seat 7. The second assembling construction 9b includes a plurality of latching blocks 841 provided on the connecting rods 82 of the light guide member 8 which are close to the light inputting ends 814, and a plurality of latching grooves 731 which are respectively formed to inner walls of the plurality of light guiding pipe receiving holes 71 of the base seat 7. The plurality of latching blocks 841 respectively latch with the plurality of the latching grooves 731. Specifically, each latching block 841 protrudes transversely from the corresponding light inputting end 814 to form a latching hook 841a. A top side of the inner wall of each latching groove 731 is provided with a latching hook cooperating portion 731a which cooperates with the latching hook 841a. The plurality of latching hook cooperating portions 731a respectively limit the plurality of latching hooks 841a, thus the latching block 841 cannot be separated from the latching groove 731 without acting of an external force, so as to increase a retention force which retains the light guide member 8 to the base seat 7.

In conclusion, by that the light guide member 8 is provided on the side cover plate 6, the corresponding side wall 113 of the guiding shield cage 1 does not need a construction and apertures which are used to assemble the light guiding pipe 81, at the same time by that the side cover plate 6 is assembled to the corresponding side wall 113 of the guiding shield cage 1, the side cover plate 6 is capable of covering some openings or opened holes on the side wall 113, the side cover plate 6 has a double technical effect of both an electromagnetic interference (EMI) shielding function and being used to assemble the light guide member 8. Moreover, by that the light guide member 8 and the side cover plate 6 are provided therebetween with the first assembling construction 9a which allows the light guide member 8 and the side cover plate 6 to cooperate with each other and the light guide member 8 and the base seat 7 are provided therebetween with the second assembling construction 9b which allows the light guide member 8 and the base seat 7 to cooperate with each other, the light guide member 8 and the base seat 7 are capable of being stably and indeed fixed on the side cover plate 6. Moreover, by that the light guide member 8 and the side cover plate 6 are therebetween provided with the interference cooperating construction 93 and the elastic latching construction 94, the light guide member 8 is capable of being more firmly fixed, and the light guide member 8 is further capable of being detached. Moreover, by that the recessed portion 935 of the retaining piece 932 and the internal protruding portion 933 of the retaining hole 931 cooperate with each other, the light guide member 8 is easy to be stably assembled. Moreover, by that in a process that the retaining piece 932 inserts into the retaining hole 931, the front protruding portion 934 firstly interferes with and scratches the internal protruding portion 933, although the internal protruding portion 933 is partially scratched but still substantially maintains as a protruding block to pass over the front protruding portion 934 and then enters into the recessed portion 935, in turn is limited by the front protruding portion 934 and the rear protruding portion 936, conversely, when the retaining piece 932 withdraws from the retaining hole 931, the internal protruding portion 933 will scratch the front protruding portion 934 again and still maintains as a protruding block to pass over the front protruding portion 934, in this way, it is beneficial for the retaining hole 931 to be capable of being assembled and used again, so the object of the present disclosure can be indeed achieved.

However, the above description is only for the embodiment of the present disclosure, and it is not intended to limit the implementing scope of the present disclosure, and the simple equivalent changes and modifications made according to the claims and the contents of the specification are still included in the scope of the present disclosure.

What is claimed is:

1. A connector assembly, comprising:
a guiding shield cage comprising a side wall;
a side cover plate assembled to the side wall of the guiding shield cage;
a light guide member comprising a plurality of light guiding pipes, each light guiding pipe having a light inputting end and a light outputting end; and
a first assembling construction provided between the light guide member and the side cover plate and used to assemble the light guide member on the side cover plate, the first assembling construction comprising an interference cooperating construction and an elastic latching construction.

2. The connector assembly of claim 1, wherein
the interference cooperating construction has a retaining hole which is formed to the light guide member, and a retaining piece which is provided to the side cover plate,
in an assembling direction that the light guide member faces the side cover plate, the retaining piece is fixed in the retaining hole by interference cooperation.

3. The connector assembly of claim 2, wherein
a side edge of the retaining piece has a front protruding portion and a recessed portion which is positioned behind the front protruding portion,
the retaining hole therein has an internal protruding portion which cooperates with the recessed portion of the side edge of the retaining piece,
the front protruding portion interferes with the internal protruding portion in the retaining hole in an inserting process of the retaining piece.

4. The connector assembly of claim 3, wherein
the side edge of the retaining piece further has a rear protruding portion which is positioned behind the recessed portion,
the recessed portion is positioned between the front protruding portion and the rear protruding portion.

5. The connector assembly of claims 2, wherein
the elastic latching construction has a latch block which is provided to the light guide member, and a latch piece which is provided to the side cover plate and is elastic,
in the assembling direction that the light guide member faces the side cover plate, the latch piece latches the latch block.

6. The connector assembly of claim 5, wherein
the light guide member further has a latch supporting portion which is integrally connected to the plurality of light guiding pipes,
the latch supporting portion of the light guide member is formed with the retaining hole and the latch block.

7. The connector assembly of claim 6, wherein
the latch supporting portion comprises a supporting rod and a plurality of connecting rods connected to the plurality of light guiding pipes,
the supporting rod of the light guide member is formed with the retaining hole, and allows the latch block to be provided thereon.

8. The connector assembly of claim 7, wherein
the latch piece has a latch hole which is used to latch the latch block.

9. The connector assembly of claim 7, wherein
a side of the latch block which faces the latch piece is provided with a guiding surface,
a side of the latch piece which faces the latch block is provided with a guiding edge which cooperates with the guiding surface.

10. The connector assembly of claim 1, wherein
the connector assembly further comprises a base seat and a second assembling construction,
the base seat comprises a plurality of light guiding pipe receiving holes, the plurality of light guiding pipe receiving holes are respectively used to receive light inputting ends of the plurality of the light guiding pipes;
the second assembling construction is provided between the light guide member and the base seat.

11. The connector assembly of claim 10, wherein
the second assembling construction comprises a plurality of latching blocks which are respectively provided to the light inputting ends of the plurality of the light guiding pipes, and a plurality of latching grooves which are respectively formed to inner walls of the plurality of light guiding pipe receiving holes of the base seat,
the plurality of latching blocks respectively latch the plurality of the latching grooves.

12. The connector assembly of claim 10, wherein
a material of the base seat is a soft material containing a rubber.

13. The connector assembly of claim 1, wherein
the guiding shield cage further comprises an assembling piece which protrudes from the side wall,
the side cover plate has an assembling hole,
the assembling piece passes through the assembling hole of the side cover plate, and latches the side cover plate.

14. The connector assembly of claim 13, wherein
the guiding shield cage further comprises a partitioning frame,
the partitioning frame has the assembling piece,
the side wall has an assembling hole,
the assembling hole of the side cover plate corresponds to the assembling hole of the side wall,
the assembling piece outwardly and sequentially passes through the assembling hole of the side wall and the assembling hole of the side cover plate, and latches the side cover plate.

15. A connector assembly, comprising:
a guiding shield cage;
a light guide member assembled on the guiding shield cage and comprising light guiding pipes, the light guiding pipe having a light inputting end and a light outputting end; and
a first assembling construction provided between the light guide member and the guiding shield cage and used to position the light guide member to the guiding shield cage, the first assembling construction comprising an interference cooperating construction, the interference cooperating construction having a retaining hole and a retaining piece, the retaining piece being fixed in the retaining hole by interference cooperation, a side edge of the retaining piece having a front protruding portion and a recessed portion which is positioned behind the front protruding portion, the retaining hole therein having an internal protruding portion which cooperates with the recessed portion of the side edge of the retaining piece, the front protruding portion interfering with the internal protruding portion in the retaining hole in an inserting process of the retaining piece.

16. The connector assembly of claim 15, wherein
the side edge of the retaining piece further has a rear protruding portion which is positioned behind the recessed portion,
the recessed portion is positioned between the front protruding portion and the rear protruding portion.

17. The connector assembly of claim 15, wherein
the first assembling construction further comprises an elastic latching construction,
the elastic latching construction has a latch block and a latch piece which is elastic, the latch piece latches the latch block.

18. The connector assembly of claim 17, wherein
the connector assembly further comprises a side cover plate,
the side cover plate is assembled on the guiding shield cage and allows the retaining piece and the latch piece to be provided thereon;
the light guide member is assembled on the side cover plate, the light guide member is formed with the retaining hole and allows the latch block be provided thereon;
the retaining hole is assembled and fixed to the retaining piece in an assembling direction that the light guide member faces the side cover plate,
the latch block is assembled and fixed to the latch piece in the assembling direction that the light guide member faces the side cover plate.

19. The connector assembly of claim 18, wherein
the light guide member further has a latch supporting portion which is integrally connected to the light guiding pipes,
the latch supporting portion of the light guide member is formed with the retaining hole and the latch block.

20. The connector assembly of claim 19, wherein
the latch supporting portion comprises a supporting rod and a plurality of connecting rods connected to the light guiding pipes,
the supporting rod of the light guide member is formed with the retaining hole, and allows the latch block to be provided thereon.

21. The connector assembly of claim 20, wherein
the latch piece has a latch hole which is used to latch the latch block.

22. The connector assembly of claim 20, wherein
the latch block has a guiding surface which faces the latch piece in an assembling process,
a side of the latch piece is further provided with a guiding edge which faces the latch block and cooperates with the guiding surface.

23. The connector assembly of claim 15, wherein
the connector assembly further comprises a base seat and a second assembling construction,
the base seat comprises light guiding pipe receiving holes, the light guiding pipe receiving holes are respectively used to receive light inputting ends of the light guiding pipes;
the second assembling construction is provided between the light guide member and the base seat.

24. The connector assembly of claim 23, wherein
the second assembling construction comprises latching blocks which are respectively provided at the light inputting ends of the he light guiding pipes and are respectively received in the light guiding pipe receiving holes, and latching grooves which are respectively formed to the base seat and are used to respectively latch the latching blocks.

25. The connector assembly of claim 23, wherein
a material of the base seat is a soft material containing a rubber.
